(19) United States
(12) Patent Application Publication
(10) Pub. No.: US 2006/0137524 A1
(43) Pub. Date: Jun. 29, 2006

(54) Gas removing apparatus for removing non-condensate gas from a heat pipe and method for the same

(76) Inventor: Jia-Hao Li, Kao Hsiung Hsien (TW)

Correspondence Address: HDSL, 4331 STEVENS BATTLE LANE, FAIRFAX, VA, 22033, US

(21) Appl. No.: 11/022,663

(22) Filed: Dec. 28, 2004

(51) Int. Cl. B01D 19/00

(52) U.S. Cl. 95/241

(57) ABSTRACT

A method and gas removing apparatus removes non-condensate gas from a heat pipe. The gas removing apparatus includes a liquid container, a heating unit, and a sealing unit. The liquid container contains a heating liquid heated by the heating unit. The sealing unit is placed atop the heating unit and outside an opening of the heat pipe. The sealing unit comprises a sealing die and a sealing mechanism for opening and closing the sealing die. The heat pipe can be heated and the non-condensate gas can be removed therefrom by thermal conduction of the heating liquid.

### BACKGROUND OF THE INVENTION

1. Field of the Invention

The present invention relates to a gas removing apparatus for removing non-condensate gas from a heat pipe and method for the same, and more particularly to a gas removing apparatus used in the process of removing non-condensate gas and method for the same.

2. Description of Prior Art

The conventional hear pipe generally includes means to remove non-condensate gas therein. For example, Taiwan patent gazette No. 593961 discloses a method and an apparatus to remove non-condensate gas in a heat pipe. However, in above patent, the apparatus clamps on the wall of the heat pipe with large contact area. The wall of the heat pipe tends to be damaged due to non-straight pipe and non-ideal design of the heating unit of the apparatus.

### SUMMARY OF THE INVENTION

The present invention is to provide a gas removing apparatus for removing non-condensate gas from a heat pipe and method for the same. The heat pipe is heated through the heat conduction by liquid. The heat pipe of varying length can be uniformly and stably heated. The heat pipe is heated by liquid and the supporting requirement can be minimized. Therefore, the skew problem due to size deviation of the heat pipe, such as asymmetric pipe, bending pipe, distorted pipe or due to non-precise machinery can be prevented.

Accordingly, the present invention provides a gas removing apparatus for removing non-condensate gas from a heat pipe and method for the same. The gas removing apparatus comprises a liquid container, a heating unit, and a sealing unit. The liquid container contains a heating liquid heated by the heating unit. The sealing unit is placed atop the heating unit and outside an opening of the heat pipe. The sealing unit comprises a sealing die and a sealing mechanism for opening and closing the sealing die. The heat pipe can be heated and the non-condensate gas can be removed therefrom by thermal conduction of the heating liquid.

The above summaries are intended to illustrate exemplary embodiments of the invention, which will be best understood in conjunction with the detailed description to follow, and are not intended to limit the scope of the appended claims.

### BRIEF DESCRIPTION OF DRAWING

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 shows a sectional view of a preferred embodiment according to the present invention.

FIG. 2 shows a sectional view for explaining the operation of the present invention.

FIG. 3 shows another sectional view for explaining the operation of the present invention.

### DETAILED DESCRIPTION OF THE INVENTION

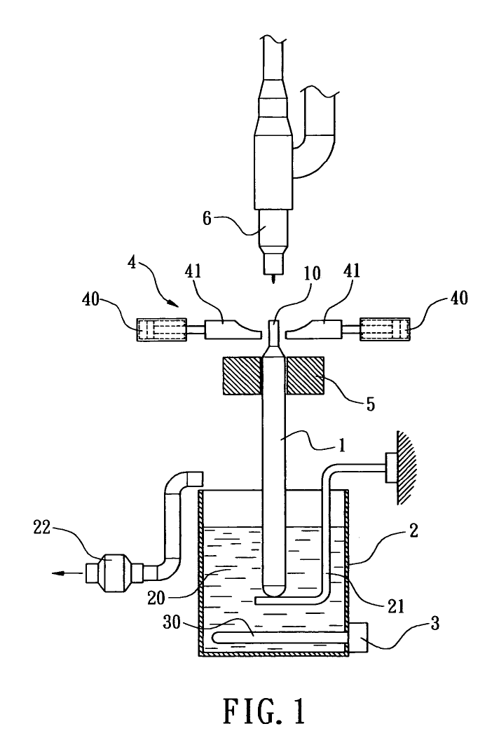

Please refer to FIG. 1 through FIG. 3, according to a preferred embodiment of the present invention. As shown in those figures, the present invention provides a gas removing apparatus for heat pipe, which can be used for single semi-finished heat pipe 1. The gas removing apparatus for heat pipe according to the present invention comprises a liquid container 2, a heating unit 3 and a sealing unit 4.

The liquid container 2 is a hollow container with opened top end, closed circumference and closed bottom end. In the liquid container 2, a heating liquid 20 such as salt water, mineral oil or vegetable oil, is added. Into the heating liquid 20, the bottom portion of the heat pipe 1 is immersed.

The heating unit 3 is used for controlling heating amount and temperature. The heating unit 3 according to the present invention comprises a heating bar 30 inserted into the liquid container 2 and near the bottom of the liquid container 2. The heating bar 30 can heat the heating liquid 20 after the heating liquid 20 is filled into the liquid container 2. Moreover, the heating unit 3 can be equipped with temperature controller (not shown) to keep a constant temperature within the liquid container 2.

The sealing unit 4 comprises a sealing die 40 and a sealing mechanism 41 for opening and closing the sealing die 40. Moreover, the sealing unit 4 is arranged atop the liquid container 2 and outside the opening of the heat pipe 1, which is to be sealed. The opening is functioned as a gas vent 10 for removing non-condensate gas for the heat pipe 1. Moreover, the sealing die 40 has heater (not shown) with controlled temperature to ensure that the temperature nearby is higher than the saturated temperature during sealing operation.

To keep an erective stand of the heat pipe 1 during the degas process, a supporting structure 21 is provided in the liquid container 2. The supporting structure 21 is an N-shaped panel with one end for supporting the bottom end of the heat pipe 1 and hanging the heat pipe 1 in the liquid container 2, and another end fixed to a rigid structure (not shown). Moreover, the supporting structure 21 can also be arranged in a way with flexible height adjustment for adapting the supporting structure 21 to heat pipe of varying length. Moreover, a distal clamping unit 5 is provided below the sealing unit 4 and placed at upper circumference of the heat pipe 1. The distal clamping unit 5 can be used with the supporting structure 21 to clamp the heat pipe 1 in erective stand. The distal clamping unit 5 is configured to fit heat pipes 1 of different pipe dimension.

The gas removing apparatus for heat pipe according to the present invention can be configured and assembled according to above description.

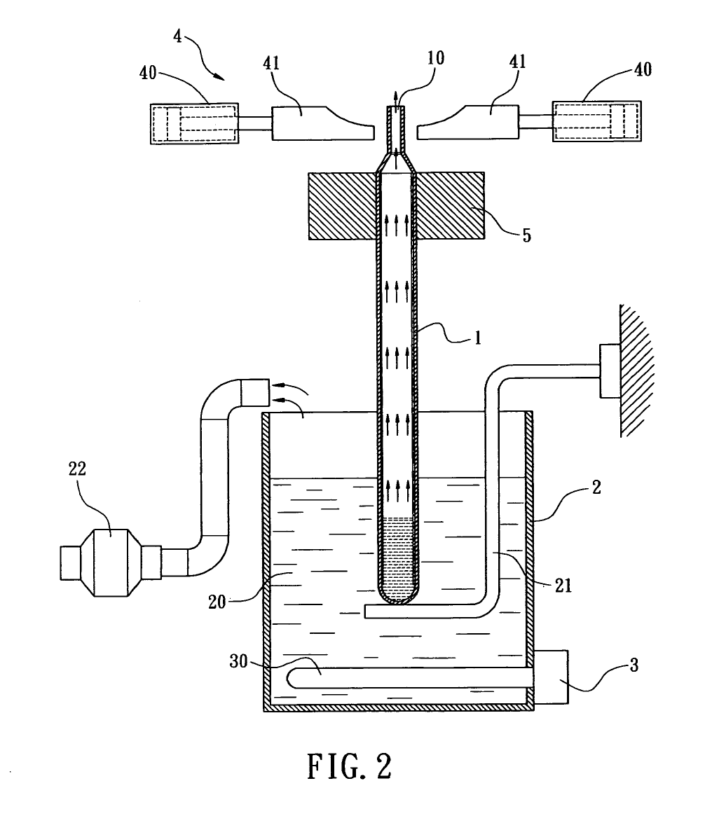

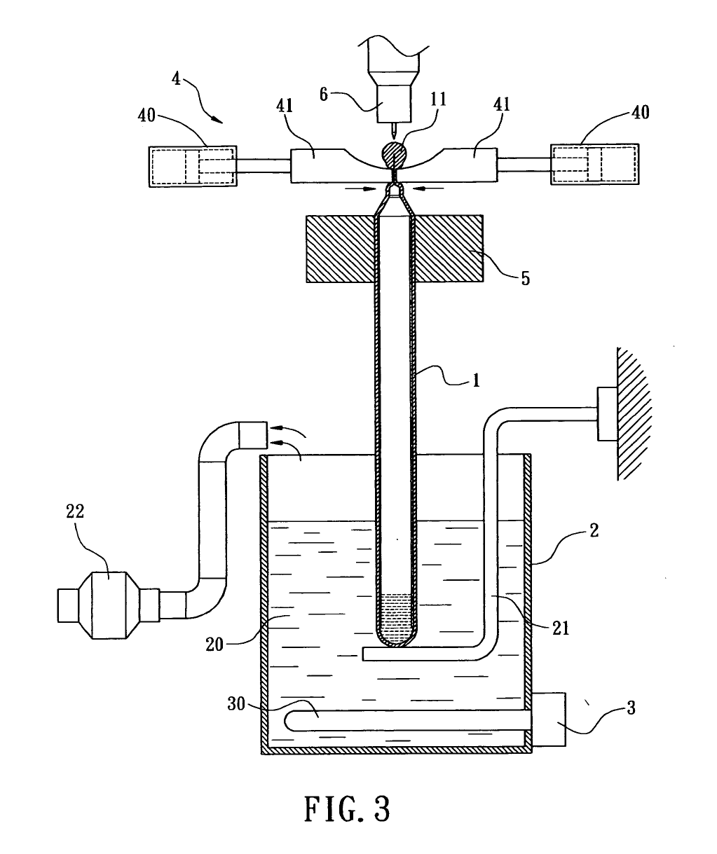

With reference to FIGS. 2 and 3, the heat pipe 1 is filled with working fluid when the heat pipe 1 is subjected to non-condensate gas removing operation. The heat pipes 1 is placed in erective stand and clamped by the supporting structure 21 to a predetermined height and further clamped by the distal clamping unit 5. The lower portion of the heat pipe 1 is immersed into the heating liquid 20. Moreover, a gas vent 10 is defined at top of the heat pipe 1 as shown in FIG. 2 and the heating unit 3 heats the heating liquid 20 of the container 2 to raise temperature of the working fluid when the gas vent 10 is still in opened state. When the working fluid reaches saturated temperature, the saturated temperature is kept until the working fluid boils and evaporates. The non-condensate gas within the pipe 1 is expelled by the evaporated fluid. The sealing unit 4 performs sealing process to the vent 10 of the heat pipe 10 when desired degas amount reaches. At this time, a spot welding unit 6 atop the sealing unit 4 performs spot welding to the vent 10 to form a sealed structure 11 as shown in FIG. 3, thus finishing degas and sealing operation for the heat pipe.

Moreover, the heating liquid 20 will produce vapor when the heating liquid 20 is heated by the heating unit 3. An air pump 22 can be provided atop the liquid container to prevent the vapor from influencing the processing of the heat pipe 1 at topside thereof. The air pump 22 exhausts the vapor resulted from the heating liquid 20, thus ensuring clean work place.

The method for removing non-condensate gas from the heat pipe can be performed by above steps.

In the method and apparatus for removing non-condensate gas from the heat pipe according to the present invention, the heat pipe 1 is heated through the heat conduction by liquid. The heat pipe 1 of varying length can be uniformly and stably heated. The heat pipe 1 is heated by liquid and the supporting requirement can be minimized. Therefore, the skew problem due to size deviation of the heat pipe, such as asymmetric pipe, bending pipe, distorted pipe or due to non-precise machinery can be prevented.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

What is claimed is:

1. A gas removing apparatus for removing non-condensate gas from a heat pipe, the gas removing apparatus comprising:
a liquid container for containing a heating liquid;
a heating unit for heating the heating liquid in the liquid container; and
a sealing unit placed atop the heating unit and outside an opening of the heat pipe, and comprising a sealing die and a sealing mechanism for opening and closing the sealing die.

2. The gas removing apparatus as in claim 1, wherein the liquid container is a hollow container with opened top end, closed circumference and closed bottom end.

3. The gas removing apparatus as in claim 1, wherein the liquid container has a supporting structure therein.

4. The gas removing apparatus as in claim 3, wherein the supporting structure is an N-shaped panel.

5. The gas removing apparatus as in claim 1, further comprising an air pump atop the liquid container.

6. The gas removing apparatus as in claim 1, wherein the heating liquid is salt is water.

7. The gas removing apparatus as in claim 1, wherein the heating liquid is mineral oil.

8. The gas removing apparatus as in claim 1, wherein the heating liquid is vegetable oil.

9. The gas removing apparatus as in claim 1, wherein the heating unit comprises a heating bar.

10. The gas removing apparatus as in claim 1, wherein the heating unit comprises a temperature controller.

11. The gas removing apparatus as in claim 1, wherein the sealing unit comprises a sealing die and a sealing mechanism for opening and closing the sealing die.

12. The gas removing apparatus as in claim 1, wherein the sealing die has a heater with controlled temperature.

13. The gas removing apparatus as in claim 1, further comprising a distal clamping unit below the sealing unit.

14. The gas removing apparatus as in claim 1, further comprising a spot welding unit atop the sealing unit.

15. A method for removing a non-condensate gas from a heat pipe, comprising the steps of:
placing the heat pipe filled with a working fluid in erective stand and clamped by a gas removing apparatus, the heat pipe having a gas vent at top thereof;
using the gas removing apparatus to heat the bottom of the heat pipe to raise temperature of the working fluid in isobaric manner when the gas vent is still in opened state; and
repelling the non-condensate gas within the pipe by an evaporated fluid produced by heating the working fluid.

16. The method as in claim 15, wherein the sealing unit of the gas removing apparatus has a sealing die with a temperature higher than a saturated temperature during sealing operation.
